(19) United States
(12) Patent Application Publication
(10) Pub. No.: US 2016/0050438 A1
(43) Pub. Date: Feb. 18, 2016

(54) VIDEO SIGNAL PROCESSING METHOD AND DEVICE

(71) Applicant: LG ELECTRONICS INC., Seoul (KR)

(72) Inventors: Jin HEO, Seoul (KR); Junghak NAM, Seoul (KR); Jiwook JUNG, Seoul (KR); Sehoon YEA, Seoul (KR); Eunyong SON, Seoul (KR)

(73) Assignee: LG ELECTRONICS INC., Seoul (KR)

(21) Appl. No.: 14/782,440

(22) PCT Filed: Apr. 11, 2014
(86) PCT No.: PCT/KR14/03134

§ 371 Date: Oct. 5, 2015

Related U.S. Application Data
(60) Provisional application No. 61/810,716, filed on Apr. 11, 2013.
(60) Provisional application No. 61/856,039, filed on Jul. 18, 2013.

(51) Int. Cl. H04N 19/597; H04N 19/44; H04N 19/503; H04N 19/176; H04N 19/182

(52) U.S. Cl. CPC H04N 19/597; H04N 19/176; H04N 19/182; H04N 19/503; H04N 19/44

(57) ABSTRACT

The present invention relates to a video signal processing method and device capable of: obtaining an intra-prediction mode for a current depth block; determining a reference neighboring pixel region adjacent to the current depth block by using the intra-prediction mode; determining a first reference neighboring pixel region and a second reference neighboring pixel region; determining a first current depth block region and a second current depth block region comprised in the current depth block; obtaining a first prediction value for the first current depth block region by using the representative value of the first reference neighboring pixel region; and obtaining a second prediction value for the second current depth block region by using the representative value of the second reference neighboring pixel region.

### TECHNICAL FIELD

The present invention relates to a method and device for processing a video signal.

### BACKGROUND ART

Compression refers to a signal processing technique for transmitting digital information through a communication line or storing the digital information in a form suitable for a storage medium. Compression targets include audio, video and text information. Particularly, a technique of compressing images is called video compression. Multiview video has characteristics of spatial redundancy, temporal redundancy and interview redundancy.

### DISCLOSURE

### Technical Problem

An object of the present invention is to improve video signal coding efficiency.

### Technical Solution

The present invention obtains prediction values of a current depth block by dividing each of a reference neighboring pixel region and a current depth block into two regions in consideration of directivity of intra-prediction.

In addition, the present invention codes the current depth block by indexing the prediction values and residuals of the current depth block using a look-up table.

The technical problems solved by the present invention are not limited to the above technical problems and those skilled in the art may understand other technical problems from the following description.

### Advantageous Effects

The present invention can reduce intra-prediction complexity by coding the current depth block by indexing at least one of a prediction value and a residual of a current depth block.

In addition, the present invention can increase intra-prediction efficiency using directivity of intra-prediction.

Furthermore, the present invention can simplify a variety of flag information regarding conventional intra-prediction into one piece of flag information of intra-prediction.

It will be appreciated by persons skilled in the art that that the effects that can be achieved through the present invention are not limited to what has been particularly described hereinabove and other advantages of the present invention will be more clearly understood from the following detailed description.

### DESCRIPTION OF DRAWINGS

FIG. 1 is a block diagram of a broadcast receiver to which depth coding is applied according to an embodiment of the present invention.

FIG. 2 is a block diagram of a video decoder according to an embodiment of the present invention.

FIG. 3 is a flowchart illustrating a first embodiment of decoding a current depth block according to intra-prediction as an embodiment to which the present invention is applied.

FIG. 4 is a flowchart illustrating a second embodiment of decoding the current depth block according to intra-prediction as an embodiment to which the present invention is applied.

FIG. 5 illustrates an example of determining a reference neighboring pixel region of the current depth block according to an embodiment to which the present invention is applied.

FIG. 6 illustrates an example of dividing the current depth block into a first current depth block region and a second current depth block region according to an embodiment to which the present invention is applied.

FIG. 7 illustrates an example of obtaining a prediction value of the current depth block according to an embodiment to which the present invention is applied.

### BEST MODE

The present invention provides a video signal processing method and device configured: to acquire an intra-prediction mode of a current depth block; to determine a reference neighboring pixel region adjacent to the current depth block using the intra-prediction mode; to determine a reference neighboring pixel boundary using pixel values of the reference neighboring pixel region; to determine a first reference neighboring pixel region and a second reference neighboring pixel region included in the reference neighboring pixel region using the reference neighboring pixel boundary; to determine a first current depth block region and a second current depth block region included in the current depth block using the reference neighboring pixel boundary; to obtain a first prediction value of the first current depth block region using a representative value of the first reference neighboring pixel region; and to obtain a second prediction value of the second current depth block region using a representative value of the second reference neighboring pixel region.

The video signal processing method and device may be configured: to obtain a first residual index corresponding to the first current depth block region and a second residual index corresponding to the second current depth block region; to convert the first residual index into a first residual using a predetermined lookup table; to convert the second residual index into a second residual using the predetermined lookup table; and to decode the current depth block using the first prediction value, the second prediction value, the first residual and the second residual.

The video signal processing method and device may be configured: to obtaining a first residual index corresponding to the first current depth block region and a second residual index corresponding to the second current depth block region; to convert the first prediction value into a first prediction index using a predetermined lookup table; to convert the second prediction value into a second prediction index using the predetermined lookup table; to obtain a first current depth block region index using the first residual index and the first prediction index; to obtain a second current depth block region index using the second residual index and the second prediction index; and to decode the current depth block using the first current depth block region index and the second current depth block region index.

The video signal processing method and device may be configured to obtain intra-prediction mode selection information and to obtain the intra-prediction mode using the intra-prediction mode selection information.

A space between neighboring pixels having a largest pixel value difference therebetween in the reference neighboring pixel region may be determined as the reference neighboring pixel boundary.

An intra-prediction mode of a texture block corresponding to the current depth block may be additionally used.

The representative value of the first reference neighboring pixel region may be the average of pixel values included in the first reference neighboring pixel region and the representative value of the second reference neighboring pixel region may be the average of pixel values included in the second reference neighboring pixel region.

### MODES FOR INVENTION

Techniques for compressing or decoding multiview video signal data consider spatial redundancy, temporal redundancy and inter-view redundancy. In the case of a multiview image, multiview texture images captured at two or more views can be coded in order to generate a three-dimensional image. Furthermore, depth data corresponding to the multiview texture images may be coded as necessary. The depth data can be compressed in consideration of spatial redundancy, temporal redundancy or inter-view redundancy. Depth data is information on the distance between a camera and a corresponding pixel. The depth data can be flexibly interpreted as depth related information such as depth information, a depth image, a depth picture, a depth sequence and a depth bitstream in the specification. In addition, coding can include both the concepts of encoding and decoding in the specification and can be flexibly interpreted within the technical spirit and technical scope of the present invention.

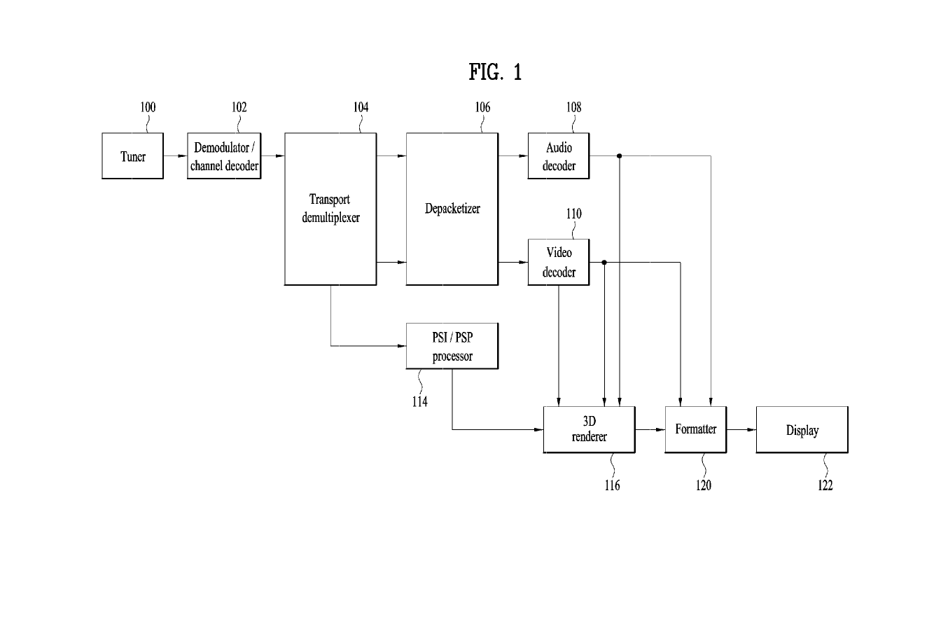

FIG. 1 is a block diagram of a broadcast receiver to which depth coding is applied according to an embodiment to which the present invention is applied.

The broadcast receiver according to the present embodiment receives terrestrial broadcast signals to reproduce images. The broadcast receiver can generate three-dimensional content using received depth related information. The broadcast receiver includes a tuner 100, a demodulator/channel decoder 102, a transport demultiplexer 104, a depacketizer 106, an audio decoder 108, a video decoder 110, a PSI/PSIP processor 114, a 3D renderer 116, a formatter 120 and a display 122.

The tuner 100 selects a broadcast signal of a channel tuned to by a user from among a plurality of broadcast signals input through an antenna (not shown) and outputs the selected broadcast signal. The demodulator/channel decoder 102 demodulates the broadcast signal from the tuner 100 and performs error correction decoding on the demodulated signal to output a transport stream TS. The transport demultiplexer 104 demultiplexes the transport stream so as to divide the transport stream into a video PES and an audio PES and extract PSI/PSIP information. The depacketizer 106 depacketizes the video PES and the audio PES to restore a video ES and an audio ES. The audio decoder 108 outputs an audio bitstream by decoding the audio ES. The audio bitstream is converted into an analog audio signal by a digital-to-analog converter (not shown), amplified by an amplifier (not shown) and then output through a speaker (not shown). The video decoder 110 decodes the video ES to restore the original image. The decoding processes of the audio decoder 108 and the video decoder 110 can be performed on the basis of a packet ID (PID) confirmed by the PSI/PSIP processor 114. During the decoding process, the video decoder 110 can extract depth information. In addition, the video decoder 110 can extract additional information necessary to generate an image of a virtual camera view, for example, camera information or information for estimating an occlusion hidden by a front object (e.g. geometrical information such as object contour, object transparency information and color information), and provide the additional information to the 3D renderer 116. However, the depth information and/or the additional information may be separated from each other by the transport demultiplexer 104 in other embodiments of the present invention.

The PSI/PSIP processor 114 receives the PSI/PSIP information from the transport demultiplexer 104, parses the PSI/PSIP information and stores the parsed PSI/PSIP information in a memory (not shown) or a register so as to enable broadcasting on the basis of the stored information. The 3D renderer 116 can generate color information, depth information and the like at a virtual camera position using the restored image, depth information, additional information and camera parameters.

In addition, the 3D renderer 116 generates a virtual image at the virtual camera position by performing 3D warping using the restored image and depth information regarding the restored image. While the 3D renderer 116 is configured as a block separated from the video decoder 110 in the present embodiment, this is merely an example and the 3D renderer 116 may be included in the video decoder 110.

The formatter 120 formats the image restored in the decoding process, that is, the actual image captured by a camera, and the virtual image generated by the 3D renderer 116 according to the display mode of the broadcast receiver such that a 3D image is displayed through the display 122. Here, synthesis of the depth information and virtual image at the virtual camera position by the 3D renderer 116 and image formatting by the formatter 120 may be selectively performed in response to a user command. That is, the user may manipulate a remote controller (not shown) such that a composite image is not displayed and designate an image synthesis time.

As described above, the depth information for generating the 3D image is used by the 3D renderer 116. However, the depth information may be used by the video decoder 110 in other embodiments. A description will be given of various embodiments in which the video decoder 110 uses the depth information.

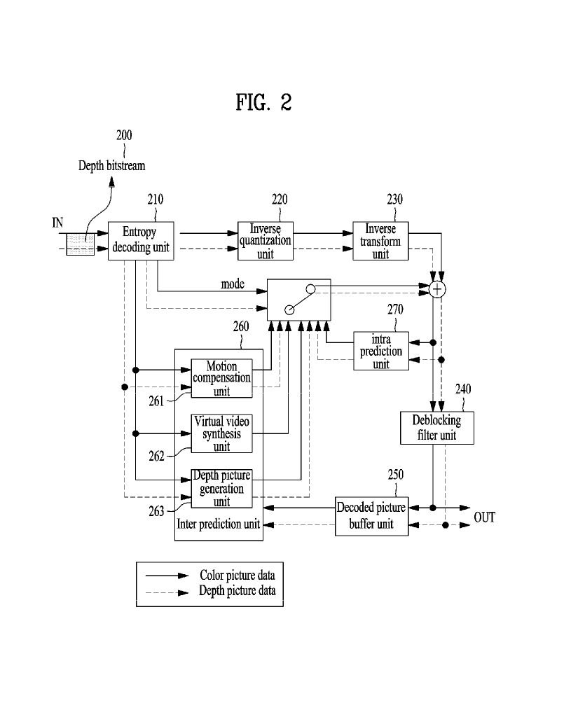

FIG. 2 is a block diagram of the video decoder according to an embodiment to which the present invention is applied.

Referring to FIG. 2, the video decoder 110 may include an entropy decoding unit 210, an inverse quantization unit 220, an inverse transform unit 230, an in-loop filter unit 240, a decoded picture buffer unit 250, an inter prediction unit 260 and an intra prediction unit 270. In FIG. 2, solid lines represent flow of color picture data and dotted lines represent flow of depth picture data. While the color picture data and the depth picture data are separately represented in FIG. 2, separate representation of the color picture data and the depth picture data may refer to separate bitstreams or separate flows of data in one bitstream. That is, the color picture data and the depth picture data can be transmitted as one bitstream or separate bitstreams. FIG. 2 only shows data flows and does not limit operations to operations performed in one decoder.

First of all, to decode a received depth bitstream 200, the depth bitstream 200 is parsed per NAL. Here, various types of attribute information regarding depth may be included in an NAL header region, an extended region of the NAL header, a sequence header region (e.g. sequence parameter set), an extended region of the sequence header, a picture header region (e.g. picture parameter set), an extended region of the picture header, a slice header region, an extended region of the slice header, a slice data region or a macro block region. While depth coding may be performed using a separate codec, it may be more efficient to add attribute information regarding depth only in the case of depth bitstream if compatibility with existing codecs is achieved. For example, depth identification information for identifying a depth bitstream can be added to the sequence header region (e.g. sequence parameter set) or the extended region of the sequence header. Attribute information regarding a depth sequence can be added only when an input bitstream is a depth coded bitstream, according to the depth identification information.

The parsed depth bitstream 200 is entropy-decoded through the entropy decoding unit 210 and a coefficient, a motion vector and the like of each macro block are extracted. The inverse quantization unit 220 multiplies a received quantized value by a predetermined constant so as to obtain a transformed coefficient and the inverse transform unit 230 inversely transforms the coefficient to restore depth information of a depth picture. The intra-prediction unit 270 performs intra-prediction using the restored depth information of the current depth picture. The deblocking filter unit 240 applies deblocking filtering to each coded macro block in order to reduce block distortion. The deblocking filter unit improves the texture of a decoded frame by smoothing edges of blocks. A filtering process is selected depending on boundary strength and an image sample gradient around a boundary. Filtered depth pictures are output or stored in the decoded picture buffer unit 250 to be used as reference pictures.

The decoded picture buffer unit 250 stores or opens previously coded depth pictures for inter prediction. Here, to store coded depth pictures in the decoded picture buffer unit 250 or to open stored coded depth pictures, frame_num and POC (Picture Order Count) of each picture are used. Since the previously coded pictures may include depth pictures corresponding to views different from the current depth picture, depth view information for identifying views of depth pictures as well as frame_num and POC can be used in order to use the previously coded pictures as reference pictures in depth coding.

In addition, the decoded picture buffer unit 250 may use the depth view information in order to generate a reference picture list for inter-view prediction of depth pictures. For example, the decoded picture buffer unit 250 can use depth-view reference information. The depth-view reference information refers to information used to indicate dependence between views of depth pictures. For example, the depth-view reference information may include the number of depth views, a depth view identification number, the number of depth-view reference pictures, depth view identification numbers of depth-view reference pictures and the like.

The decoded picture buffer unit 250 manages reference pictures in order to implement more flexible inter prediction. For example, a memory management control operation method and a sliding window method can be used. Reference picture management unifies a reference picture memory and a non-reference picture memory into one memory and manages the unified memory so as to achieve efficient management with a small-capacity memory. In depth coding, depth pictures can be separately marked to be discriminated from color pictures in the decoded picture buffer unit and information for identifying each depth picture can be used in the marking process. Reference pictures managed through the aforementioned procedure can be used for depth coding in the inter prediction unit 260.

Referring to FIG. 2, the inter-prediction unit 260 may include a motion compensation unit 261, a virtual view synthesis unit 262 and a depth picture generation unit 263.

The motion compensation unit 261 compensates for motion of the current block using information transmitted from the entropy decoding unit 210. The motion compensation unit 261 extracts motion vectors of neighboring blocks of the current block from a video signal and acquires a motion vector prediction value of the current block. The motion compensation unit 261 compensates for motion of the current block using the motion vector prediction value and a differential vector extracted from the video signal. Motion compensation may be performed using one reference picture or a plurality of pictures. In depth coding, motion compensation can be performed using information on a reference picture list for inter-view prediction of depth pictures stored in the decoded picture buffer unit 250 when the current depth picture refers to a depth picture of a different view. Further, motion compensation may be performed using depth view information for identifying the view of the depth picture.

The virtual view synthesis unit 262 synthesizes a color picture of a virtual view using color pictures of neighboring views of the view of the current color picture. To use the color pictures of the neighboring views or to use color pictures of a desired specific view, view identification information indicating the views of the color pictures can be used. When the color picture of the virtual view is generated, flag information indicating whether the color picture of the virtual view is generated can be defined. When the flag information indicates generation of the color picture of the virtual view, the color picture of the virtual view can be generated using the view identification information. The color picture of the virtual view, acquired through the virtual view synthesis unit 262, may be used as a reference picture. In this case, the view identification information can be assigned to the color picture of the virtual view.

In another embodiment, the virtual view synthesis unit 262 can synthesize a depth picture of a virtual view using depth pictures corresponding to neighboring views of the view of the current depth picture. In this case, depth view identification information indicating the view of a depth picture can be used. Here, the depth view identification information can be derived from view identification information of a corresponding color picture. For example, the corresponding color picture can have the same picture output order information and the same view identification information as the current depth picture.

The depth picture generation unit 263 can generate the current depth picture using depth coding information. Here, the depth coding information may include a distance parameter indicating a distance between a camera and an object (e.g. a Z-coordinate value on a camera coordinate system or the like), macro block type information for depth coding, information for identifying a boundary in a depth picture, information indicating whether data in RBSP includes depth-coded data, information indicating whether a data type is depth picture data, color picture data or parallax data and the like. In addition, the current depth picture may be predicted using the depth coding information. That is, inter prediction using neighboring depth pictures of the current depth picture can be performed and intra prediction using decoded depth information in the current depth picture can be performed.

The present invention proposes a method for intra-predicting the current depth block in the depth picture generation unit 263 and a method for decoding the current depth block using a prediction value of the current depth block, obtained through intra-prediction, and a residual index obtained from a bitstream.

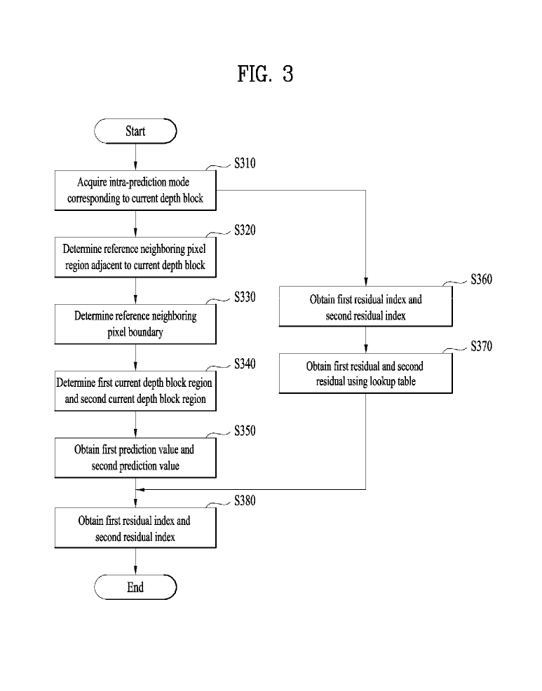

A description will be given of a first embodiment of intra-prediction according to the present invention with reference to FIG. 3.

FIG. 3 is a flowchart illustrating the first embodiment of decoding the current depth block according to intra-prediction as an embodiment to which the present invention is applied.

An intra-prediction mode corresponding to the current depth block may be obtained (S310). For example, intra-prediction mode selection information conventional_flag is acquired from a bitstream and an intra-prediction mode indicated by the intra-prediction mode selection information is obtained as the intra-prediction mode of the current depth block. Alternatively, the intra-prediction mode of the current depth block may be obtained using an intra-prediction mode of a texture block corresponding to the current depth block. Otherwise, the intra-prediction mode of the current depth block may be obtained using an intra-prediction mode of a neighboring depth block of the current depth block.

A reference neighboring pixel region used for intra-prediction may be determined (S320). The reference neighboring pixel region indicates a region including at least one reference neighboring pixel used for intra-prediction. A reference neighboring pixel may be a pixel referred to by the current depth block in intra-prediction. In addition, the reference neighboring pixel may be included a neighboring block of the current depth block, instead of the current depth block.

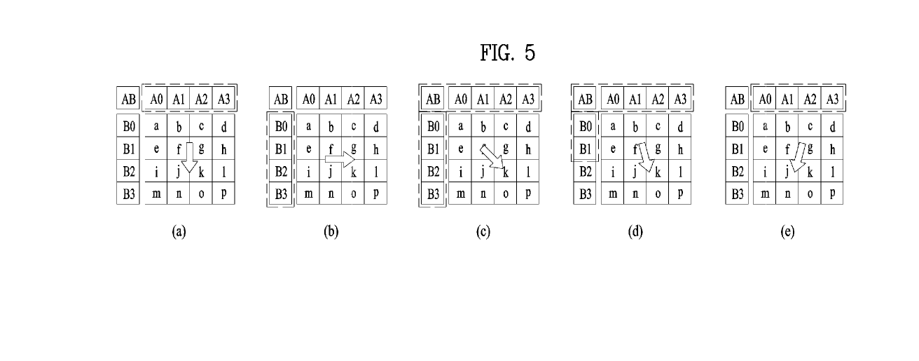

The reference neighboring pixel region used for intra-prediction may be determined in response to directivity of the intra-prediction mode. An embodiment of determining the reference neighboring pixel region used for intra-prediction will be described later with reference to FIG. 5.

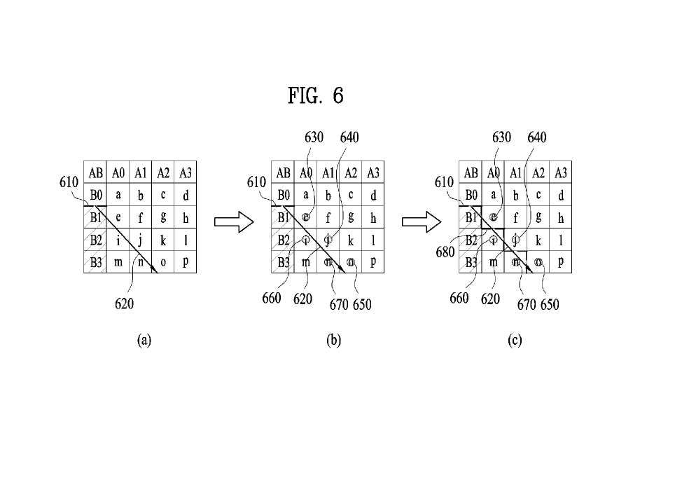

A reference neighboring pixel boundary may be determined using pixel values within the reference neighboring pixel region (S330). The reference neighboring pixel boundary can indicate a boundary for dividing the reference neighboring pixel region into regions. The reference neighboring pixel boundary may be determined as a boundary between reference neighboring pixels having a largest pixel value difference from among reference neighboring pixels within the reference neighboring pixel region. An embodiment of determining the reference neighboring pixel boundary will be described later with reference to FIG. 6.

The reference neighboring pixel region may be divided into a first reference neighboring pixel region and a second reference neighboring pixel region by the reference neighboring pixel boundary. The first reference neighboring pixel region and the second reference neighboring pixel region may indicate regions within the reference neighboring pixel region, which are divided by the reference neighboring pixel boundary.

A first current depth block region and a second current depth block region may be determined (S340). The first current depth block region and the second current depth block region are included in the current depth block and may be obtained using the reference neighboring pixel boundary and the intra-prediction mode obtained in S310. An example of determining the first current depth block region and the second current depth block region will be described later with reference to FIG. 6.

A prediction value of the first current depth block region and a prediction value of the second current depth block region may be obtained (S350). The prediction value (referred to as a first prediction value hereinafter) of the first current depth block region and the prediction value (referred to as a second prediction value hereinafter) of the second current depth block region may be obtained using the pixel values within the reference neighboring pixel region. For example, the first prediction value can be obtained using pixel values within the first reference neighboring pixel region and the second prediction value can be obtained using pixel values within the second reference neighboring pixel region. The first prediction value can be obtained using the average of the pixel values within the first reference neighboring pixel region and the second prediction value can be obtained using the average of the pixel values within the second reference neighboring pixel region. Alternatively, the first prediction value can be obtained using a pixel of the first reference neighboring pixel region, which is the closest to each pixel in the first current depth block region, and the second prediction value can be obtained using a pixel of the second reference neighboring pixel region, which is the closest to each pixel in the second current depth block region. Otherwise, the first prediction value and the second prediction value may be values gradually increasing/decreasing from pixel values of pixels in the first reference neighboring pixel region and the second reference neighboring pixel region, respectively.

A first residual index and a second residual index may be obtained (S360). The first residual index indicates a converted value of a residual corresponding to a difference between a pixel value of the original image, which is included in the first current depth block region, and a pixel value of a predicted image, which is included in the first current depth block region. The second residual index indicates a converted value of a residual corresponding to a difference between a pixel value of the original image, which is included in the second current depth block region, and a pixel value of a predicted image, which is included in the second current depth block region. The first residual index and the second residual index may be transmitted from an encoder and obtained from a bitstream.

A first residual and a second residual may be obtained using a lookup table (S370). The first residual is a difference between a pixel value of the original image, which is included in the first current depth block region, and a pixel value of the predicted image, which is included in the first current depth block region, and may be obtained by converting the first residual index using the lookup table. The second residual is a difference between a pixel value of the original image, which is included in the second current depth block region, and a pixel value of the predicted image, which is included in the second current depth block region, and may be obtained by converting the second residual index using the lookup table. Here, the lookup table is used to convert a residual to a residual index or to convert a residual index to a residual, and may be transmitted from the encoder or generated by a decoder.

The current depth block may be decoded using the first prediction value, the second prediction value, the first residual and the second residual (S380). For example, the first current depth block region can be decoded by summing the first prediction value and the first residual and the second current depth block region can be decoded by summing the second prediction value and the second residual.

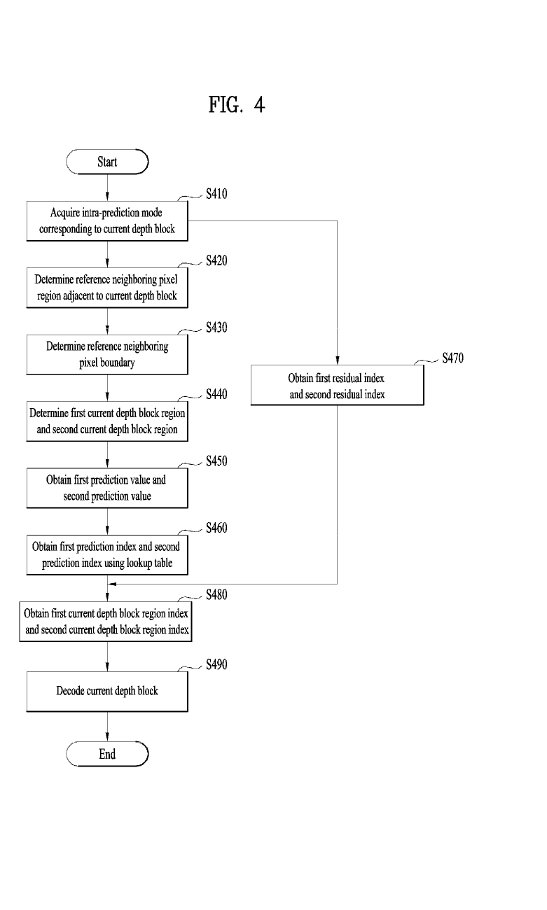

A description will be given of a second embodiment of intra-prediction according to the present invention with reference to FIG. 4.

FIG. 4 is a flowchart illustrating the second embodiment of decoding the current depth block according to intra-prediction according to the present invention.

Steps S410 to S450 corresponds to steps S310 to S350 described in FIG. 3 and thus detailed description thereof is omitted.

A first prediction index and a second prediction index may be obtained (S460). The first prediction index corresponds to a prediction value of the predicted image, which corresponds to the first current depth block region, and may be obtained by converting the first prediction value through the lookup table. The second prediction index corresponds to a prediction value of the predicted image, which corresponds to the second current depth block region, and may be obtained by converting the second prediction value through the lookup table.

A first residual index and a second residual index may be obtained (S470), which corresponds to step S360 described in FIG. 3.

A first current depth block region index and a second current depth block region index may be obtained (S480). The first current depth block region index corresponds to a restored value of the current depth block region and may be acquired by summing the first prediction index and the first residual index. The second current depth block region index corresponds to a restored value of the current depth block region and may be acquired by summing the second prediction index and the second residual index.

The current depth block may be decoded using the first current depth block region index and the second current depth block region index (S490). The current depth block may be decoded by converting the first current depth block region index into a restored value of the first current depth block region through the lookup table. In addition, the current depth block may be decoded by converting the second current depth block region index into a restored value of the second current depth block region through the lookup table.

The first embodiment differs from a second embodiment in that the current depth block is decoded by converting a residual index into a residual and summing the residual and a prediction value in the former, whereas the current depth block is decoded by indexing a prediction value, summing a prediction index and a residual index and then converting the sum in the latter.

A description will be given of an example of determining the reference neighboring pixel region in S320 and S420 with reference to FIG. 5.

FIG. 5 illustrates an example of determining a reference neighboring pixel region of the current depth block according to an embodiment of the present invention.

In FIG. 5, a to p indicate pixels in the current depth block, A0 to A3 indicate upper reference neighboring pixels of the current depth block, B0 to B3 represent left reference neighboring pixels of the current depth block, and AB represents a left upper reference neighboring pixel of the current depth block.

FIGS. 5(a) to (e) illustrate reference neighboring pixel regions determined in response to the intra-prediction mode of the current depth block.

FIG. 5(a) shows a reference neighboring pixel region when the intra-prediction mode of the current depth block corresponds to the vertical direction. The reference neighboring pixel region can be determined as a region including upper reference neighboring pixels including A0, A1, A2 and A3 when the intra-prediction mode of the current depth block corresponds to the vertical direction.

FIG. 5(b) shows a reference neighboring pixel region when the intra-prediction mode of the current depth block corresponds to the horizontal direction. The reference neighboring pixel region can be determined as a region including left reference neighboring pixels including B0, B1, B2 and B3 when the intra-prediction mode of the current depth block corresponds to the horizontal direction.

FIG. 5(c) shows a reference neighboring pixel region when the intra-prediction mode of the current depth block corresponds to 45-degree direction (lower right direction). In this case, the reference neighboring pixel region can be determined as a region including reference neighboring pixels including A0 to A3, B0 to B3 and AB or a region including reference neighboring pixels including A0 to A2, B0 to B2 and AB.

FIG. 5(d) shows a reference neighboring pixel region when the intra-prediction mode of the current depth block corresponds to 22.5-degree direction (lower right direction). In this case, the reference neighboring pixel region can be determined as a region including reference neighboring pixels including A0 to A3, B0, B1 and AB.

FIG. 5(e) shows a reference neighboring pixel region when the intra-prediction mode of the current depth block corresponds to −22.5-degree direction (lower left direction). In this case, the reference neighboring pixel region can be determined as a region corresponding to reference neighboring pixels including A4 to A7 (not shown) as well as A0 to A3. Here, A4 to A7 indicate reference neighboring pixels disposed to the right of A3.

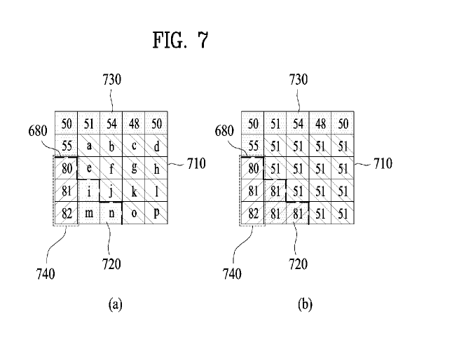

A description will be given of the embodiment of intra-prediction, described in FIGS. 3 and 4, with reference to FIGS. 6 and 7. In FIGS. 6 and 7, description is made on the assumption that the intra-prediction mode corresponds to 45-degree direction (lower right direction) and the reference neighboring pixel region includes A0 to A3, B0 to B3 and AB.

An example of dividing the current depth block into the first current depth block region and the second current depth block region will now be described with reference to FIG. 6.

FIG. 6 illustrates an example of dividing the current depth block into the first current depth block region and the second current depth block region according to an embodiment of the present invention.

FIG. 6(a) shows the intra-prediction mode of the current depth block and the reference neighboring pixel region boundary 610 determined in S330 or S430. The reference neighboring pixel region boundary 610 can be determined as a space between pixels having a largest pixel value difference therebetween from among pixels corresponding to the reference neighboring pixel region. For example, when B0 and B1 have a largest pixel value difference therebetween from among the pixels corresponding to the reference neighboring pixel region, the space between B0 and B1 can be determined as the reference neighboring pixel region boundary 610. A current depth block delimitation line 620 may be determined form the reference neighboring pixel region boundary 610. The current depth block delimitation line 620 indicates a line that delimits the current depth block in the same direction as the direction corresponding to the intra-prediction mode of the current depth block.

FIG. 6(b) shows an example of determining a boundary for dividing the current depth block into the first and second current depth block regions by comparing the current depth block delimitation line 620 with the centers of pixels 630 to 670 included in the current depth block and adjacent to the current depth block delimitation line 620. For example, the pixels 630 to 670 can be classified into the pixels 630 to 650 having centers disposed above the current depth block delimitation line 620 and the pixels 660 and 670 having centers below the current depth block delimitation line 620.

The boundary 680 for dividing the current depth block may be determined on the basis of the classified pixels 630 to 670, as shown in FIG. 6(c). The first current depth block region and the second current depth block region may be determined according to the boundary 680.

A description will be given of an example of obtaining prediction values of the current depth block using reference neighboring pixels with reference to FIG. 7.

FIG. 7 illustrates an example of obtaining prediction values of the current depth block according to an embodiment of the present invention.

For example, when the current depth block is divided into the first current depth block region 710 (a to h, j, k, l, o and p) and the second current depth block region 720 (i, m and n) by the boundary 680, as shown in FIG. 7(a), a prediction value of the first current depth block region 710 can be obtained using pixel values included in the first reference neighboring pixel region 730 and a prediction value of the second current depth block region 720 can be obtained using pixel values included in the second reference neighboring pixel region 740.

Referring to FIG. 7(b), the average, 51, of pixel values 50, 51, 54, 48, 50 and 55 included in the first reference neighboring pixel region 730 can be obtained as the prediction value of the first current depth block region 710. In addition, the average, 81, of pixel values 80, 81 and 82 included in the second reference neighboring pixel region 740 can be obtained as the prediction value of the second current depth block region 720.

A description will be given of an example of generating a lookup table when the lookup table is generated in a decoder.

The lookup table can be generated on the basis of a predetermined depth picture. However, when the depth pixel used to generate the lookup table and a depth picture which does not affect generation of the lookup table have different characteristics, an inappropriate lookup table may decrease efficiency. To solve this problem, 1) the lookup table may be updated on a depth picture basis or 2) the lookup table may be updated on the basis of a period of a depth picture coded using intra-prediction.

According to the first method, a depth value in a depth picture is detected during indexing of the depth picture using the lookup table. When the detected depth value is not included in the lookup table, depth index information corresponding to the depth value is added to the lookup table so as to update the lookup table. Depth index information, which is not used in the depth picture while being present in the lookup table, is removed to update the lookup table. The updated lookup table can be continuously updated during search and indexing of depth values on a depth picture basis.

The second method of updating the lookup table on the basis of a period of a depth picture coded according to intra-prediction will now be described. For example, if the period of the depth picture coded according to intra-prediction is 16, the lookup table can be updated for every 16 depth pictures. The lookup table can be updated by checking whether indexed depth values are present in the lookup table as in the first method.

As described above, a decoding/encoding apparatus to which the present invention is applied may be included in a multimedia broadcast transmission/reception apparatus such as a DMB (digital multimedia broadcast) system to be used to decode video signals, data signals and the like. In addition, the multimedia broadcast transmission/reception apparatus may include a mobile communication terminal.

A decoding/encoding method to which the present invention is applied may be implemented as a computer-executable program and stored in a computer-readable recording medium and multimedia data having a data structure according to the present invention may also be stored in a computer-readable recording medium. The computer-readable recording medium includes all kinds of storage devices storing data readable by a computer system. Examples of the computer-readable recording medium include a ROM, a RAM, a CD-ROM, a magnetic tape, a floppy disk, an optical data storage device, and a medium using a carrier wave (e.g. transmission through the Internet). In addition, a bitstream generated according to the encoding method may be stored in a computer-readable recording medium or transmitted using a wired/wireless communication network.

### INDUSTRIAL APPLICABILITY

The present invention can be used to code a video signal.

1. A method for processing a video signal, comprising:
acquiring an intra-prediction mode of a current depth block;
determining a reference neighboring pixel region adjacent to the current depth block using the intra-prediction mode;
determining a reference neighboring pixel boundary using pixel values of the reference neighboring pixel region;
determining a first reference neighboring pixel region and a second reference neighboring pixel region included in the reference neighboring pixel region using the reference neighboring pixel boundary;
determining a first current depth block region and a second current depth block region included in the current depth block using the reference neighboring pixel boundary;
obtaining a first prediction value of the first current depth block region using a representative value of the first reference neighboring pixel region; and
obtaining a second prediction value of the second current depth block region using a representative value of the second reference neighboring pixel region.

2. The method according to claim 1, further comprising:
obtaining a first residual index corresponding to the first current depth block region and a second residual index corresponding to the second current depth block region;
converting the first residual index into a first residual using a predetermined lookup table;
converting the second residual index into a second residual using the predetermined lookup table; and
decoding the current depth block using the first prediction value, the second prediction value, the first residual and the second residual.

3. The method according to claim 1, further comprising:
obtaining a first residual index corresponding to the first current depth block region and a second residual index corresponding to the second current depth block region;
converting the first prediction value into a first prediction index using a predetermined lookup table;
converting the second prediction value into a second prediction index using the predetermined lookup table;
obtaining a first current depth block region index using the first residual index and the first prediction index;
obtaining a second current depth block region index using the second residual index and the second prediction index; and
decoding the current depth block using the first current depth block region index and the second current depth block region index.

4. The method according to claim 1, further comprising obtaining intra-prediction mode selection information,
wherein the obtaining of the intra-prediction mode of the current depth block comprises obtaining the intra-prediction mode using the intra-prediction mode selection information.

5. The method according to claim 1, wherein the determining of the reference neighboring pixel boundary using the pixel values of the reference neighboring pixel region comprises determining a space between neighboring pixels having a largest pixel value difference therebetween in the reference neighboring pixel region as the reference neighboring pixel boundary.

6. The method according to claim 1, wherein the determining of the first current depth block region and the second current depth block region included in the current depth block using the reference neighboring pixel boundary is performed using an intra-prediction mode of a texture block corresponding to the current depth block.

7. The method according to claim 1, wherein the representative value of the first reference neighboring pixel region is the average of pixel values included in the first reference neighboring pixel region and the representative value of the second reference neighboring pixel region is the average of pixel values included in the second reference neighboring pixel region.

8. A device for processing a video signal, comprising:
a depth picture generator configured to acquire an intra-prediction mode of a current depth block, to determine a reference neighboring pixel region adjacent to the current depth block using the intra-prediction mode, to determine a reference neighboring pixel boundary using pixel values of the reference neighboring pixel region, to determine a first reference neighboring pixel region and a second reference neighboring pixel region included in the reference neighboring pixel region using the reference neighboring pixel boundary, to determine a first current depth block region and a second current depth block region included in the current depth block using the reference neighboring pixel boundary, to obtain a first prediction value of the first current depth block region using a representative value of the first reference neighboring pixel region and to obtain a second prediction value of the second current depth block region using a representative value of the second reference neighboring pixel region.

9. The device according to claim 8, wherein the depth picture generator is configured to obtain a first residual index corresponding to the first current depth block region and a second residual index corresponding to the second current depth block region, to convert the first residual index into a first residual using a predetermined lookup table, to convert the second residual index into a second residual using the predetermined lookup table and to decode the current depth block using the first prediction value, the second prediction value, the first residual and the second residual.

10. The device according to claim 8, wherein the depth picture generator is configured to obtain a first residual index corresponding to the first current depth block region and a second residual index corresponding to the second current depth block region, to convert the first prediction value into a first prediction index using a predetermined lookup table, to convert the second prediction value into a second prediction index using the predetermined lookup table, to obtain a first current depth block region index using the first residual index and the first prediction index, to obtain a second current depth block region index using the second residual index and the second prediction index and to decode the current depth block using the first current depth block region index and the second current depth block region index.

11. The device according to claim 8, wherein the depth picture generator is configured to obtain intra-prediction mode selection information and to obtain the intra-prediction mode using the intra-prediction mode selection information.

12. The device according to claim 8, wherein the depth picture generator determines a space between neighboring pixels having a largest pixel value difference therebetween in the reference neighboring pixel region as the reference neighboring pixel boundary.

13. The device according to claim 8, wherein the depth picture generator uses an intra-prediction mode of a texture block corresponding to the current depth block.

14. The device according to claim 8, wherein the representative value of the first reference neighboring pixel region is the average of pixel values included in the first reference neighboring pixel region and the representative value of the second reference neighboring pixel region is the average of pixel values included in the second reference neighboring pixel region.
